(19) United States
(12) Patent Application Publication
(10) Pub. No.: US 2009/0275284 A1
(43) Pub. Date: Nov. 5, 2009

(54) Method and Apparatus for Transferring Data to a Vehicle

(76) Inventor: Joseph Risolia, Miami, FL (US)

Correspondence Address: Christopher E. Haigh, 2038 N. Clark, #105, Chicago, IL, 60614, US

(21) Appl. No.: 11/743,316

(22) Filed: May 2, 2007

Related U.S. Application Data
(60) Provisional application No. 60/848,892, filed on Oct. 3, 2006.

(51) Int. Cl. H04B 7/00; G06F 17/30; G06F 12/00

(52) U.S. Cl. 455/41.3; 707/104.1; 711/103

(57) ABSTRACT

A method and apparatus for transmitting data from a transmitter to a vehicle is disclosed. The method may include the steps of transmitting data from a transmitter, receiving data in a vehicle, and storing the data received at the vehicle for eventual playback in the vehicle. The apparatus may comprise a database having data stored therein, a transmitter in electronic communication with the database, and a receiver positioned on or in a vehicle, the receiver being configured to receive transmitted data.

### RELATED APPLICATIONS

This application is related to U.S. Provisional Application No. 60/848,892, filed on Oct. 3, 2006, incorporated herein by reference.

### FIELD OF THE INVENTION

The present invention relates generally to a method and apparatus for transferring data, and more specifically relates to a method and apparatus for transferring data to a vehicle.

### BACKGROUND OF THE INVENTION

In the automobile/vehicle industry, a vehicle may be outfitted with a stereo or similar sound equipment. However, it may be desired to have an interactive system in which the stereo may be updated with music that the user would like to listen to—regardless of whether that music is currently being played “over the air.”

Accordingly, a system or method that permits “downloading” or transmission of data, such as music or video, to the vehicle is desirable.

### SUMMARY OF THE INVENTION

The present invention relates to one or more of the following features, elements or combinations thereof. A method and apparatus for transferring data to a vehicle is disclosed. The apparatus comprises a database having data stored therein and a transmitter in electronic communication with the database. The transmitter may be located remote from the vehicle and configured to transmit data. A receiver may be coupled to the vehicle, and configured to receive data from the transmitter.

A portable database can be in communication with the receiver, the portable database being configured to store the data after it is received. The transmitter and database may be in electronic communication via the Internet. The transmitter and receiver may communicate via Bluetooth, radio frequency, infrared, electronic transmission over a wire, or any wireless technique known in the art.

In one embodiment, the transmitter is located at a drive-through for a business establishment and the receiver is located either on the exterior or the interior of the vehicle. The receiver may be coupled to the vehicle stereo system, or may be coupled to the vehicle exterior sound system, i.e. the horn. The portable database may be an MP3 player, and may comprise either a flash drive or a hard drive.

A method of transmitting data to a vehicle is also disclosed. The method may include the steps of transmitting data from a transmitter, receiving data in a vehicle, and storing the data received at the vehicle for eventual playback in the vehicle. The vehicle stereo may be used for playback of the received data. In an alternative embodiment, the received data may be played back through a vehicle external speaker. The method may also include the step of transmitting information, such as credit card or user information, from the vehicle to the transmitter.

### BRIEF DESCRIPTION OF THE DRAWINGS

FIG. 1 is a schematic illustration of one embodiment of the apparatus disclosed herein.

### DETAILED DESCRIPTION OF EMBODIMENTS OF THE INVENTION

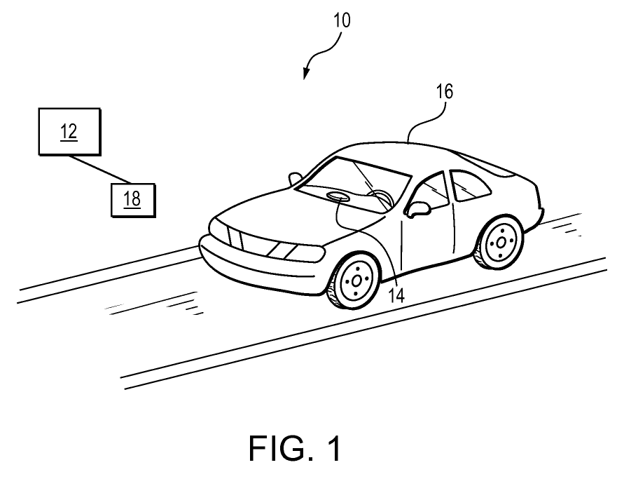

As can be seen from FIG. 1, an apparatus 10 for transferring data to a vehicle is disclosed. The apparatus includes a transmitter 12 that transmits data to a receiver 14 in a vehicle 16. The receiver 14 may be connected to or in communication with the vehicle's stereo system, a television, a processor, or any other type of electrical system in the vehicle. In one embodiment, the receiver is connected to the vehicle stereo system and is capable of receiving audio and/or video files from the transmitter 12. In another embodiment, the receiver is connected to a vehicle external speaker system (i.e. a horn), and is capable of receiving audio files that can be played over the external speaker system.

The receiver 14 may be located either inside or outside the vehicle 16. However, receiver 14 should be positioned such that a transmission from transmitter 12 can reach receiver 14.

Transmission may occur in any way known in the art. For example, transmitter 12 may transmit via radio frequency (RF), Bluetooth, satellite signals, or infrared. It is contemplated that blue tooth is a suitable and practical means for transmission, as many vehicles are now integrating blue tooth receivers into the vehicle for other purposes already. Of course, it is also possible for the transmitter 12 and receiver 14 to utilize a wired connection.

Transmitter 12 may be linked to a database 18 having transmittable content. For example, transmitter 12 may be linked to a database of songs or videos which can be transmitted to the vehicle 16 for eventual use by vehicle inhabitants. However, it should be understood that other transmittable content is within the scope of this disclosure. For example, database 18 may house sounds that can be emitted from the vehicle's exterior speaker system, such as in the case of a customizable horn.

Database 18 may or may not be present in the same location as transmitter 12. It is contemplated that database 18 may be located at a central location and accessible by a variety of transmitters, such access being facilitated by the Internet or any other electronic communication means. In the alternative, database 18 may be incorporated with transmitter 12 such that the two devices comprise a single unit.

It is contemplated that transmitter 12 may be installed near a drive-through path, such that a vehicle driver could drive up to the transmitter and download data without even leaving the vehicle. Payment could be made via credit card, cash, coin, or even processed using the same connection through which the data is transferred. In such an embodiment, the vehicle receiver could be configured to also transmit information to the transmitter 12, such as credit card or customer information that would permit tracking and/or payment for the downloaded data. One contemplated example would be to have a receiver 14 that is connected to a processor in the vehicle. The processor, when prompted, would direct the receiver to send stored data, such as credit card or other identification data, to the transmitter for payment processing.

It is also contemplated that transmitter 12 could be used as a gimmick or selling point at a drive-through window. For example, a fast food restaurant could offer customers a free download for orders that exceed a certain value. Then, while the customer is waiting in line, he/she could download the free data.

It is contemplated that transmitter 12 would be coupled with a user interface, such as a touch screen monitor or a keyboard. The touch screen monitor could display content available, and if desirable for the establishment hosting the transmitter, provide sampling of the content. Such a feature could be turned on or off pursuant to the establishment's wishes.

The receiver 14 could be coupled to a portable database 20, the portable database 20 operatively storing data for eventual retrieval. In one embodiment, the portable database 20 could be coupled to the vehicle 16. In another embodiment, the portable database 20 could be removably coupled to the vehicle 16, such as in the case of a portable hard (i.e. flash) drive that can be used to store digital content for retrieval in any number of locations inside or outside of the vehicle. One well-known example of such a portable hard drive is an MP3 player.

In another embodiment, a method of transmitting data to a receiver is disclosed. The method includes the steps of transmitting data from a transmitter, receiving data in a vehicle, and storing the data received at the vehicle.

While the disclosure is susceptible to various modifications and alternative forms, specific exemplary embodiments thereof have been shown by way of example in the drawings and have herein been described in detail. It should be understood, however, that there is not intent to limit the disclosure to the particular embodiments disclosed, but on the contrary, the intention is to cover all modifications, equivalents, and alternatives falling within the spirit and scope of the disclosure as defined by the appended claims.

There is a plurality of advantages of the present invention arising from the various features of the method and apparatus for transferring data to a vehicle described herein. It will be noted that alternative embodiments of the method herein disclosed may not include all of the features described yet still benefit from at least some of the advantages of such features. Those of ordinary skill in the art may readily devise their own implementations of a method and apparatus for transferring data to a vehicle that incorporate one or more of the features of the present invention and fall within the spirit and scope of the present invention as defined by the appended claims.

What is claimed is:

1. An apparatus for transferring data to a vehicle, the apparatus comprising a database having data stored therein,
a transmitter in electronic communication with the database, the transmitter being located remote from the vehicle and configured to transmit data,
a receiver coupled to the vehicle, the receiver configured to receive data from the transmitter, and
a portable database in communication with the receiver, the portable database storing the data after it is received.

2. The apparatus of claim 1, wherein the transmitter and database are in electronic communication via the Internet.

3. The apparatus of claim 1, wherein the transmitter and receiver communicate using at least one communication technology selected from the group comprising Bluetooth, radio frequency, infrared, electronic transmission over a wire, and wireless.

4. The apparatus of claim 1, wherein the transmitter is located at a drive-through for a business establishment.

5. The apparatus of claim 1, wherein the receiver is located on the exterior of the vehicle.

6. The apparatus of claim 1, wherein the receiver is located inside the vehicle.

7. The apparatus of claim 1, wherein the receiver is couple to the vehicle stereo system.

8. The apparatus of claim 1, wherein the portable database is an MP3 player.

9. The apparatus of claim 1, wherein the portable database comprises at least one of a flash drive and a hard drive.

10. An apparatus for transferring data to a vehicle, the apparatus comprising a database having data stored therein,
a transmitter in electronic communication with the database, the transmitter being located remote from the vehicle and configured to transmit data, and
a receiver coupled to the vehicle, the receiver configured to receive data from the transmitter and store the data after it is received.

11. The apparatus of claim 1, wherein the transmitter and database are in electronic communication via the Internet.

12. The apparatus of claim 1, wherein the transmitter and receiver communicate using at least one communication technology selected from the group comprising Bluetooth, radio frequency, infrared, electronic transmission over a wire, and wireless.

13. The apparatus of claim 1, wherein the transmitter is located at a drive-through for a business establishment.

14. The apparatus of claim 1, wherein the receiver is located on the exterior of the vehicle.

15. The apparatus of claim 1, wherein the receiver is located inside the vehicle.

16. The apparatus of claim 1, wherein the receiver is couple to the vehicle stereo system.

17. A method of transmitting data to a vehicle, the method comprising the steps of
transmitting data from a transmitter,
receiving data in a vehicle,
and storing the data received at the vehicle for eventual playback in the vehicle.

18. The method of claim 17, further comprising the step of using the vehicle stereo for playback of the received data.

19. The method of claim 17, further comprising the step of playing back the received data through a vehicle external speaker.

20. The method of claim 17, further comprising the step of transmitting information from the vehicle to the transmitter.
